(19) United States
(12) Patent Application Publication
(10) Pub. No.: US 2014/0010965 A1
(43) Pub. Date: Jan. 9, 2014

(54) COATING COMPOSITION FOR ICE AND SNOW REMOVAL ON CEMENTITIOUS SURFACES

(71) Applicants: Jigui Li, Santa Ana, CA (US); Ming-Ren Tarng, Irvine, CA (US); Xiaowu Fan, Santa Ana, CA (US); Jinzhen Shi, Fountain Valley, CA (US)

(72) Inventors: Jigui Li, Santa Ana, CA (US); Ming-Ren Tarng, Irvine, CA (US); Xiaowu Fan, Santa Ana, CA (US); Jinzhen Shi, Fountain Valley, CA (US)

(73) Assignee: BEHR PROCESS CORPORATION, Santa Ana, CA (US)

(21) Appl. No.: 13/544,803

(22) Filed: Jul. 9, 2012

(51) Int. Cl. C09K 3/18; B05D 5/00

(52) U.S. Cl. 427/385.5; 252/70

(57) ABSTRACT

Methods for enhancing the deicing properties of a cementitious substrate using a polymer-based coating are provided. Coating formulations and coated cementitious surfaces are also provided. The methods comprise applying an aqueous emulsion to a surface of the cementitious substrate and allowing the aqueous emulsion to dry, such that a continuous, fluorine-containing, polymeric coating is formed over the surface of the cementitious substrate. When applied to a cementitious surface, the coating penetrates into the underlying cementitious substrate and bonds with the substrate to provide the cementitious surface with hydrophobic and other properties that improve the deicing properties of the surface.

### BACKGROUND

The present application relates generally to the field of surface coatings. More specifically, the present application relates to coatings for cementitious surfaces and, in particular, coatings that ease removal of ice and snow.

Accumulation of snow and ice can pose many problems, and various solutions have been proposed to aid in their removal. For example, in winter, water may freeze to sidewalks, driveways, and roads creating slippery conditions for pedestrians and vehicles. Deicing chemicals such as salt and glycol may be applied to accumulated ice and snow. While these chemicals are effective at melting ice in certain conditions, they may be toxic to humans, pets, plants and the environment and may cause damage to paving substrates.

Ice may also accumulate on metal surfaces such as wings of airplanes and satellite dishes, which adds unnecessary weight and degrades certain critical properties such as an airplane's aerodynamic characteristics, e.g., lift and drag. Chemicals and coatings (e.g., NuSil R-2180 and Vellox LC-410) may be applied to metal surfaces as a pretreatment that reduces bonding forces between wings and later-accumulated ice. While such pretreatment chemicals are effective as applied to airplanes, they are solvent-based, applied mostly to metals, and leave a film on treated surfaces.

Various polymer-based coatings have been used as sealants to impart water and stain-resistance to cement surfaces. However, these coatings do not necessarily provide improved deicing properties, even in the case where hydrophobic polymers are used.

It would be advantageous to provide a way of treating cementitious or other types of surfaces to ease removal of snow and ice. It would further be advantageous to provide a coating for cementitious or other types of surfaces that is environmentally friendly and that does not adversely affect the appearance of surfaces to which it is applied.

### SUMMARY

Methods for enhancing the deicing properties of a cementitious substrate using a polymer-based coating are provided. Coating formulations and coated cementitious surfaces are also provided. The methods comprise applying an aqueous emulsion to a surface of the cementitious substrate and allowing the aqueous emulsion to dry, such that a continuous, fluorine-containing, polymeric coating is formed over the surface of the cementitious substrate. When applied to a cementitious surface, the coating penetrates into the underlying cementitious substrate and chemically bonds with the substrate to provide the cementitious surface with hydrophobic and other properties that improve the deicing properties of the surface. The improved deicing properties are evidenced by the fact that ice formed on the cementitious substrate surface comprising the continuous, polymeric coating is more easily removed than ice formed on the cementitious substrate surface in the absence of the coating.

In some embodiments, the deicing properties of the coating are provided or enhanced by fluorine-containing molecules. The fluorine atoms of the fluorine-containing molecules may be part of the polymer component in the coating, may be included in the coating in the form of fluorinated additives, or both.

The polymer in the coating may be an inorganic polymer (i.e., a large molecule having a backbone of non-carbon (e.g., Si) atoms), an organic polymer (i.e., a large molecule having a backbone of carbon atoms) or a combination thereof. Examples of organic polymers are acrylic polymers and fluorocarbon polymers. Examples of inorganic polymers are silicon-based polymers, such as polysilanes and polysiloxanes. These may be fluorinated polysilanes (fluorosilanes) and fluorinated polysiloxanes (fluorosiloxanes). In some embodiments, the polymers can be in the form of a sol-gel. In some embodiments, the aqueous emulsion comprises at least 4.5 weight percent of the polymer and at least 4.9 weight percent water, based on the total weight of the aqueous emulsion.

In addition to the water and the polymer, the water-based emulsions can further comprise other additives. Such additives include preservatives, defoamers and pH adjustors.

### BRIEF DESCRIPTION OF THE DRAWINGS

FIG. 1 is a schematic diagram of a cross-sectional view of the apparatus for measuring ice/ice bonding failure stress using the Zero Degree Cone method (Courtesy of U.S. Army Cold Regions Research and Engineering Laboratory; minor modification of size and geometry were made for measurements used in the present application).

### DETAILED DESCRIPTION

Methods and coating compositions for enhancing the deicing properties of cementitious substrates are provided. According to an exemplary embodiment, the coating composition is a water-based emulsion that includes one or more fluorine-containing active compounds. After drying, the emulsions form a durable hydrophobic coating that imparts improved deicing performance to a substrate onto which it is applied. The coatings may additionally impart improved water and oil resistance to the substrate and may be formulated such that they are completely or partially transparent such that they do not alter the physical appearance of the substrate upon which they are applied.

The improved deicing properties that the present coating impart to cementitious substrate surfaces can be quantified using a Zero Degree Cone (ZDC) test, as described in Example 2 below, to determine their ice/substrate bonding failure stress. Some embodiments of the present coatings provide an ice/substrate bonding failure stress of 1000 kPa or less, as measured by the ZDC test. This includes coatings that provide an ice/substrate bonding failure stress of 900 kPa or less, 800 kPa or less, 700 kPa or less and 600 kPa or less, as measured by the ZDC test.

Cementitious substrate materials that can benefit from the present coatings include porous materials such as cement, concrete, terra cotta, sandstone and limestone. Structures made from these materials onto which the coatings may be applied include sidewalks and other walkways, driveways, parking lots and roads.

The aqueous emulsions should include enough of the active polymer component to provide a coating with deicing properties. Thus, in some embodiments, the emulsions comprise at least 4.9 weight percent of the polymer component. This includes emulsions that comprise at least 8 weight percent of the polymer component and further includes embodiments that include at least 10 weight percent of the polymer component.

Specific examples of polymers that can be used in the coatings are fluorosilane sol-gels, such as Dow Corning 6706W commercially available from Dow Corning Corporation of Midland, Mich., fluorosiloxanes, and acrylic resins blended with fluorine-containing additives (e.g., a fluorinated surfactant). Examples of polymer blends that can be used in the coatings are blends of silanes and/or siloxanes with fluorocarbon polymers, such as Wacker BS 29A, which are commercially available from Wacker Chemie AG of München, Germany, blends of fluorosiloxanes with silanes and/or siloxanes and blends of fluorosilanes with silanes and/or siloxanes. Dow Corning IE6683 and IE6694, which are commercially available from Dow Corning Corporation of Midland, Mich., are examples of suitable silane/siloxane emulsions. According to another exemplary embodiment, the polymer is a silane emulsion (e.g., Wacker BS17040, which is commercially available from Wacker Chemie AG of Munchen, Germany). DuPont TLF-10579 (available from DuPont Corporation of Wilmington, Del.) is an example of acrylic resin blended with fluorine-containing additives, that can be used as the active ingredient of the coating. In this case, the acrylic resin forms a coating film matrix while the fluorinated molecules of the fluoro additives inside the matrix provide the enhanced hydropobic properties.

The coatings can also include small amounts of additives, including preservatives, defoamers and pH adjusters. These additives are typically present in small quantities (e.g., no greater than about 1 weight percent and, more typically, no greater than about 0.5 weight percent) in the water-based emulsions.

The coatings may include one or more preservatives for providing the coatings with enhanced stability and shelf life. An example of a suitable preservative is Vantocil IB, which is commercially available from Arch Chemicals, Inc. of Norwalk, Conn. However, other types of preservatives may be used. Preservatives can be present in the aqueous emulsions in quantities of, for example, 0.05 to 0.2 wt. %.

The coatings may include one or more defoamers for suppressing the formation of foam in the coatings or to effectively destroy foam bubbles once they are formed. The defoamers are desirably included at loadings that provide smooth and even application of the coatings and proper penetration of the coatings into concrete substrates. An example of a suitable defoamer is BYK 024, which is commercially available from BYK-Chemie GmbH of Wesel, Germany. However, other types of defoamers may be used. Defoamer can be present in the aqueous emulsions in quantities of, for example, 0.01 to 0.1 wt. %.

The coatings may include one or more pH adjustors for controlling the pH level of the coatings within a predetermined acceptable range (e.g., between approximately 7 and 9) and for providing shelf stability. In this manner, the coatings can advantageously be configured so as not to etch or otherwise degrade substrates to which they are applied. An example of a suitable pH adjustor is ammonia. However, other types of pH adjustors may be used. pH adjustors can be present in the aqueous emulsions in quantities of, for example, 0.01 to 0.1 wt. %.

Table 1, while not intended as limiting, provides possible ranges for the various components in some embodiments of the present aqueous emulsions.

TABLE 1

| Component | wt % |
|---|---|
| Polymer (active ingredient) | 4.9-94.9 |
| Water | 4.9-94.9 |
| Preservative | 0.05-0.2 |
| Defoamer | 0.01-0.1 |
| pH Adjustor | 0.01-0.1 |

According to one exemplary embodiment, the coating is a water-based emulsion made by combining and mixing the ingredients. For example, the water, active coating ingredient (polymer), preservative, defoamer, and pH adjuster are poured into a container and subsequently mixed by stirring.

The ingredients may be mixed together by a manufacturer and sold to a consumer pre-mixed, or some or all of the ingredients may be provided to a consumer for mixing. The ingredients may be mixed in a large container and subsequently stored or transferred into smaller containers for storage or transport and sale to consumers, or the ingredients may be mixed in containers for direct sale to consumers.

According to one exemplary embodiment, a process forming the present coatings includes preparing the substrate surface, applying the aqueous emulsion, and drying the applied aqueous emulsion to form the polymer-based, deicing-enhancing coating on the substrate surface. The surface to which the coating is applied should be prepared prior to application of the coating, such as by clearing debris and applying preparation chemicals. For example, before applying the coating, the cementitious surface can be etched with a concrete etcher (e.g., Behr 991-N, which is commercially available from Behr Process Corporation of Santa Ana, Calif.), cleaned with water, and dried for one day outdoors. The etching and cleaning exposes fresh concrete surface to allow for the formation of strong chemical bonds with silane/siloxane components in the coatings. The coating then can be applied to the cementitious surface with a brush and allowed to dry.

Those skilled in the art will recognize that the cementitious surface may be prepared in other manners including, but not limited to, clearing debris, etching, cleaning with water or other cleaners, drying via exposure to the outdoors or heaters/fans, or any combination thereof. Those skilled in the art will also recognize that the coating may be applied in other manners including, but not limited to, applying multiple coats, spraying, pouring, curing via exposure to air/sunlight/heat, manually removing excess emulsion, or any combination thereof.

Cementitious surfaces treated with coatings, such as those described herein, exhibit improved deicing characteristics as compared to the same surfaces in the absence of the coatings. Without intending to be bound to any particular theory of the invention, the inventors believe that the enhanced deicing properties that the coatings provide to cementitious surfaces can be explained by a balancing of a combination of effects. First, the coatings provided by the water-based emulsions are hydrophobic. As a result the coatings tend to repel water, preventing its penetration into and accumulation on the substrate surface. The corresponding reduced presence of water on the cementitious surface reduces the opportunity for ice formation and accumulation. In addition, the fluorinated polymers or fluorinated additives in the coatings render them able to repel other hydrophobic liquids, oil-based liquids, such as oils or antifreeze, making them useful as stain-resistant coatings. Second, the coating can act as a physical barrier between the substrate of the cementitious surface and ice that forms on the coatings, thereby preventing bonding between the substrate and ice. Third, the bonding force between ice and the coating can be less than that between ice and the substrate, thereby lessening the force required to remove ice from the coated surfaces as compared to an untreated surface. Notably, however, these effects do not necessarily go hand-in-hand. For example, the inventors have discovered that polymeric active ingredients that optimize or maximize the water-repellency of a coating do not necessarily optimize or maximize the deicing properties of the coatings. Similarly, the inventors have discovered that enhanced stain-resistance and enhanced deicing properties do not always flow from the same polymer active ingredients.

Thus, certain embodiments of the present coatings represent an improvement over known coatings for cementitious substrates in that they are able to provide a combination of good water repellency, good stain resistance and enhanced deicing properties. Moreover, the deep penetration and strong chemical bonding of the polymers in the coatings to the substrates make them durable, such that they can provide improved properties over many icing and deicing cycles. Coatings comprising fluorinated siloxanes, fluorinated silanes and blends of these are particularly well-suited to achieve these ends. Some such embodiments of the coatings comprise a blend of one or more of these fluorinated polymers with other polymers that enhance the water-repellency of the coatings but do not themselves provide the same enhanced deicing properties that the fluorinated polymers provide. For example, in some embodiments, the coatings comprise a blend of fluorinated silanes and/or fluorinated siloxanes with non-fluorinated polymers, such as non-fluorinated silanes (e.g., an alkylalkoxysilane) and/or non-fluorinated siloxanes. By way of illustration only, in such blends the fluorinated polymer can make up about 5 to about 95 wt. % of the polymer ingredients in the coating and the non-fluorinated polymer can make up about 5 to about 95 wt. % of the polymer ingredients in the coating. These coatings can be applied as aqueous emulsions made by blending the fluorinated polymers with aqueous emulsions of the non-fluorinated polymers. Examples of suitable non-fluorinated siloxanes and silanes include alkylalkoxysilanes (e.g., Behr 980), and silane-siloxanes (e.g., Dow Corning IE 6694 and Dow Corning IE 6683). Examples of suitable blends can be made from a fluorosilane sol-gel (e.g., Dow Corning 6706W) with a silane-siloxane emulsion (e.g., Dow Corning IE 6694) and/or from a fluorosiloxane and a silane-siloxane emulsion (e.g., Dow Corning IE 6683).

Table 2, while not intended as limiting, provides possible ranges for the various components in some embodiments of the present aqueous emulsions that include a blend of polymers.

TABLE 2

| Component | wt % |
|---|---|
| Fluorinated Polymer (active | 2.5-47.5 |
| ingredient) | |
| Other Polymer | 2.5-47.5 |
| Water | 4.9-94.9 |
| Preservative | 0.05-0.2 |
| Defoamer | 0.01-0.1 |
| pH Adjustor | 0.01-0.1 |

### EXAMPLES

### Example 1

### Qualitative Testing of Deicing Properties

This example illustrates the improved deicing properties imparted to a concrete surface by the present coatings.

Concrete slabs measuring 12×12×1 inch were etched with Behr 991-N concrete etcher, cleaned with water, dried in outdoor conditions for one day, and treated with a coating using a one brush-coat application. The coating comprised 50 wt. % 6706W, 49.8 wt. % water, and 0.2 wt. % additives. After curing in outdoor conditions for two days, the slabs were submerged in water and placed in a freezer for two days, allowing the water to freeze. Deicing tests were conducted by breaking the ice layer formed on the surface of the concrete slab with a metal hammer. Deicing performance was evaluated by the difficulty of breaking/removing ice and by a visual inspection of the amount of ice left on the surfaces of the concrete slabs. Control concrete slabs (i.e., uncoated) were prepared and tested together with the coated concrete slabs.

During the deicing procedure, the ice on the coated concrete slabs was easily broken and detached from the surfaces of the slabs using moderate impacts from a metal hammer. With the same effort, substantially less ice was removed from the uncoated control slab. In addition, improved liquid resistance (e.g., water, oil, antifreeze, transmission fluid, and brake fluid) was observed for the coated concrete slabs as compared to the uncoated control concrete slab. These results were determined by the observation of the beading of the liquids on the coated slab compared to the spreading of the liquids on the uncoated slab.

### Example 2

### Quantitative Testing of Deicing Properties

This example illustrates the improved deicing properties, as measured by the Zero Degree Cone (ZDC) test, imparted to concrete surfaces by the present coatings. The ZDC test, conducted at the Department of the Army, Engineer Research and Development Center, Cold Regions Research and Engineering Laboratory (CRREL), is conducted as follows: first water is frozen into ice in the annular gap between two concentric, cylindrical surfaces, and then the force required to push the inner cylinder (sample pile) out of the ice collar and outer cylinder (mold) is measured. The force is then converted to ice/ice bonding failure stress which is reported as the result. In ZDC tests, the outer cylinder is made of aluminum, and the inner cylinders are made of coated or uncoated concrete. The ZDC test, developed by CRREL in 1990s, is a well-known test method used to achieve quantitative results for ice-substrate bonding strength by the ice-phobic coatings industry.

Concrete piles were prepared by using RapidSet® concrete mix (CTS Cement Manufacturing Corporation in Cypress, Calif.) and a custom-made aluminum mold. The concrete mix was mixed with water at an approximately 4:1 weight ratio, and then filled into the aluminum mold. After curing overnight, the concrete pile was taken out of mold and then allow to dry outdoors for 30 days for full curing.

A total of ten concrete samples were tested: one sample of bare concrete without a coating, four coated samples treated with the coating formulations shown in Table 3, five replicate samples, and two stainless steel piles used as controls to make sure there was no systematic error. The loadings of active ingredient in each coating formula were normalized to make sure all wet coating samples had the same active solid content for a valid comparison of the ZDC test results. Before the tests, concrete piles were prepared and treated with the liquid coating using the same cleaning, application, and drying procedures as those used for concrete slabs.

TABLE 3

| | | | | Total additives |
|---|---|---|---|---|
| | Concrete Surface | | Loading | loading |
| No. | Coating | Active Ingredient | (wt. %) | (wt. %) |
| 1 | NA (Bare concrete) | NA | 0 | 0 |
| 2 | Coating composition A | BS-17040 (silane | 17.9 | 0.2 |
| | | emulsion) | | |
| 3 | Coating composition B | arylic resin with | 99.8 | 0.2 |
| | | fluoro additive | | |
| 4 | Coating composition C | 6706W | 50.9 | 0.2 |
| | | (fluorosilane sol- | | |
| | | gel) | | |
| 5 | Coating composition D | fluorosiloxane | 51.9 | 0.2 |

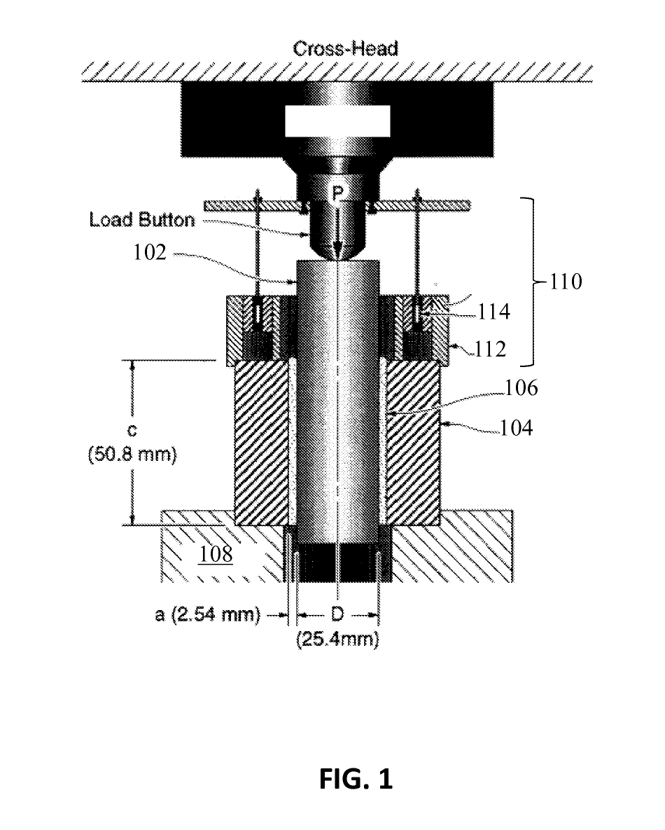

FIG. 1 is a schematic diagram of a cross-sectional view of a typical apparatus and sample set-up for carrying out the ZDC tests for metal or plastic piles that have relatively smooth surfaces. Modifications of the concrete pile 102 and outer aluminum cylinder 104 were made to accommodate testing of concrete pile samples that have relatively rough surface. The actual testing set-up includes an inner cylinder of concrete 102 having a diameter of 25.4 mm and a height of 60 mm, nested in an outer cylinder of aluminum 104 which has a screw thread (⅛ inch depth) machined out at the inner surface of the cylinder. The aluminum cylinder 104 has a thickness (measured from the inner surface of the thread to the outer surface of the cylinder) of 26.7 mm and a height of 30.5 mm.

A 2.54 mm gap 106 separating the outer surface of the inner cylinder from the inner thread surface of the outer cylinder is filled with ice. The nested cylinder assembly is held in place between a pedestal 108 and a linear variable differential transformer (LVDT) assembly 110. LVDT assembly 110 includes an LVDT collar 112 and LVDT core 114 and is configured to measure the load displacement. After the samples are frozen for eight hours at −10° C. and then allowed to rest for another 40 hours, the failure stress is measured by applying a load at a constant rate of 0.06 mm/min until the ice-pile bond fails. The load is applied to the upper surface of the pile using a load cell 116 having a load button 118 configured to apply a downward pressure on the upper surface of the pile. Shear stress is calculated from the measured maximum load divided by the surface area of the coated pile/ice interface.

Table 4 shows the test results for the average failure stress for each of the samples tested. The standard deviation of failure stress is listed in the rightmost column in the table.

TABLE 4

| | Concrete Surface | Active Coating | Average Failure | Std Dev |
|---|---|---|---|---|
| No. | Coating | Ingredient | Stress (kPa) | (kPa) |
| 1 | None | None (Bare concrete) | 1874 | 187 |
| 2 | Coating | silane emulsion | 1288 | 338 |
| | composition A | | | |
| 3 | Coating | arylic resin with fluoro | 916 | 228 |
| | composition B | additive | | |
| 4 | Coating | fluorosilane sol-gel | 1033 | 185 |
| | composition C | | | |
| 5 | Coating | fluorosiloxane | 573 | 38 |
| | composition D | | | |

It is clear from the data that ice-concrete bonding was significantly weakened by the coatings. Composition B, C and D demonstrate two to three fold reductions of failure stress as compared to the bare concrete. In addition, the coatings with fluoro ingredients (compositions B, C and D) would be easier to deice because they require less force to break the ice than the coating composition without fluoro ingredients (composition A).

As utilized herein, the terms “approximately,” “about,” “substantially”, and similar are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

It is important to note that the coating as described in the various exemplary embodiments is illustrative only. Although only a few embodiments have been described in detail in this disclosure, those skilled in the art who review this disclosure will readily appreciate that many modifications are possible without materially departing from the novel teachings and advantages of the subject matter described herein. All such variations are intended to be within the scope of the present invention.

What is claimed is:

1. A method for enhancing the deicing properties of a cementitious substrate, the method comprising applying an aqueous emulsion to a surface of the cementitious substrate and allowing the aqueous emulsion to dry, such that a continuous, fluorine-containing, polymeric coating is formed over the surface of the cementitious substrate, wherein the aqueous emulsion comprises:
(a) at least one of a fluorinated polymer or a blend of a non-fluorinated polymer and a fluorine-containing compound; and
(b) at least 5 weight percent water, based on the total weight of the aqueous emulsion;
and further wherein ice formed on the cementitious substrate surface comprising the continuous, fluorine-containing, polymeric coating is more easily removed than ice formed on the cementitious substrate surface in the absence of the coating.

2. The method of claim 1, wherein the aqueous emulsion comprises the fluorinated polymer.

3. The method of claim 2, wherein the aqueous emulsion comprises at least 4 weight percent of the fluorinated polymer.

4. The method of claim 3, wherein the fluorinated polymer is a fluorinated polysiloxane.

5. The method of claim 3, wherein the fluorinated polymer is a fluorinated polysilane.

6. The method of claim 1, wherein the aqueous emulsion comprises the non-fluorinated polymer and the fluorine-containing compound, and further wherein the non-fluorinated polymer is a polyacrylic.

7. The method of claim 2, wherein the average failure stress for ice formed on the cementitious substrate surface comprising the continuous, fluorine-containing, polymeric coating is no greater than 1000 kPa, as measured by a ZDC test.

8. The method of claim 2, wherein the average failure stress for ice formed on the cementitious substrate surface comprising the continuous, fluorine-containing, polymeric coating is no greater than 800 kPa, as measured by a ZDC test.

9. The method of claim 2, wherein the average failure stress for ice formed on the cementitious substrate surface comprising the continuous, fluorine-containing, polymeric coating is no greater than 600 kPa, as measured by a ZDC test.

10. The method of claim 4, wherein the cementitious substrate is concrete and the average failure stress for ice formed on the cementitious substrate surface comprising the continuous, fluorine-containing, polymeric coating is no greater than 600 kPa, as measured by a ZDC test.

11. The method of claim 10, wherein the aqueous emulsion further comprises a defoamer and a pH adjustor.

12. The method of claim 2, wherein the fluorinated polymer is a fluorinated polysiloxane or a fluorinated polysilane and the aqueous emulsion further comprises at least one of a non-fluorinated polysilane or a non-fluorinated polysiloxane.

13. The method of claim 12, wherein the aqueous emulsion comprises about 2.5 to about 47.5 weight percent of the fluorinated polymer and about 2.5 to about 47.5 weight percent of the at least one non-fluorinated polysilane or non-fluorinated polysiloxane.

14. The method of claim 2, wherein the fluorinated polymer is the only polymer in the aqueous emulsion.

15. The method of claim 1, wherein the cementitious substrate is a road, a sidewalk or a driveway.

16. A composition for deicing a cementitious substrate, the composition comprising 2.5 to 47.5 weight percent fluorosiloxane; 2.5 to 47.5 weight percent of non-fluorinated, polysilane, non-fluorinated polysiloxane or a combination thereof; and at least 5 weight percent water, the composition characterized in that when the composition is coated onto a cementitious substrate and allowed to dry, it will form a continuous, fluorine-containing polymeric coating from which ice is more easily removed than is ice formed on the cementitious substrate in the absence of the coating.

17. The composition of claim 16, comprising a non-fluorinated alkylalkoxysilane.

18. The composition of claim 16, comprising a non-fluorinated silane-siloxane.

19. The composition of claim 16, wherein the composition consists essentially of the fluorosiloxane; the non-fluorinated, polysilane, non-fluorinated polysiloxane or the combination thereof; water; defoamer; preservative and pH adjustor.
